(19) United States
(12) Patent Application Publication
(10) Pub. No.: US 2008/0101330 A1
(43) Pub. Date: May 1, 2008

(54) METHOD FOR WIRELESSLY CONNECTING AND CONFIGURING ACCESS POINTS AND ACCESS POINT CLIENTS

(76) Inventor: Eric Cheng, Taipei (TW)

Correspondence Address: SINORICA, LLC, 528 FALLSGROVE DRIVE, ROCKVILLE, MD, 20850, US

(21) Appl. No.: 11/555,599

(22) Filed: Nov. 1, 2006

(51) Int. Cl. H04J 3/06

(52) U.S. Cl. 370/350

(57) ABSTRACT

A method for easily connecting electronic devices, wireless access points, and access point clients and for efficiently configuring and managing the connections in a manner that doesn't require a user to physically connect the electronic device to the access point is disclosed. Access Points are set to AP mode upon power up. The electronic device scans the environment for available connections and displays the information in a user interface. The interface displays the topology of the network, the relationship of the access points, and the connection status. Users can easily configure the network and access points wirelessly. All connection information and configuration data is stored in a database on the computer. Users are notified of any incompatibility issues and if any devices are not detected.

### BACKGROUND OF THE INVENTION

1. Field of the Invention

The present invention relates to connecting electronic devices. More specifically, the present invention discloses a method for easily connecting electronic devices, wireless access points, and access point clients and for efficiently managing the connections in a manner that doesn't require a user to physically connect the electronic device to the access point.

2. Description of the Prior Art

In the past, computers needed to be physically connected to a modem using a cable in order to access the Internet. This requires users to locate their computer in close proximity to the network connection. This is often inconvenient since the user cannot locate the computer in an ideal location. If a user locates the computer farther away from the network connection long cables are required to connect the computer to the network. This cabling is unsightly. In order to increase convenience for users, wireless network connections were invented.

An access point (AP) is a device for connecting another device such as a notebook computer to a wired network such as a local area network (LAN). The AP is physically connected to the wired network and wirelessly connects to the computer.

The AP is a hardware device or a computer's software that acts as a communication hub. APs provide heightened wireless security and extend the physical range of a wireless LAN.

Refer to FIG. 1, which is a block diagram illustrating a conventional wireless network environment.

Traditionally, a wireless network environment 100 includes a computer 110 and an access point 120. The access point 120 wirelessly connects the computer 110 to the Internet 130.

To install a conventional access point 120 a user must perform a number of steps in order to complete the set up. Some of the required steps are to set the 802.11 settings such as transmit power, encryption, authentication, request-to-send/clear-to-send, and fragmentation. If any of these settings are incorrect, the access point 120 will be unable to communicate with the computer 110.

In addition to these settings, the user must manually configure the Internet Protocol (IP) address. In order to configure the IP address the user must physically connect the computer 110 to the access point 120 via a serial cable. This is time consuming and inconvenient for the user.

In order to configure the access point 120, the user must use a configuration program running on the computer 110 while the computer 110 is physically connected to the access point 120. The user must also configure the access point 120 to a specific role such as access point, client access point, repeater, etc.

The detailed steps required to complete the installation are often too complex for most users. As a result, the installation usually needs to be performed by a professional technical consultant which can be expensive.

Refer to FIG. 2, which is a block diagram illustrating typical difficulties involved in using a conventional wireless network.

While an AP 120 improves the convenience of wirelessly connecting to the Internet 130, conventional APs 120 are inconvenient to set up. Additionally, it is very difficult for a typical user to troubleshoot communication problems. If the user's computer 110 is unable to establish a connection with the AP 120, the user is unable to identify the problem. They only know that the network connection failed.

Furthermore, if a user needs to reconfigure the configuration of their network the computer 110 must be physically reconnected to the access point 120 and the above installation routine must be performed again.

As a result, users are easily frustrated when trying to set up or manage their wireless network. Furthermore, since these problems are common in conventional wireless network systems, users have been slow to adopt APs.

Therefore, there is need for an improved method for easily connecting electronic devices, wireless access points, and access point clients and for efficiently managing the connections that doesn't require a user to physically connect the electronic device to the access point.

### SUMMARY OF THE INVENTION

To achieve these and other advantages and in order to overcome the disadvantages of the conventional method in accordance with the purpose of the invention as embodied and broadly described herein, the present invention provides a method for easily connecting and configuring a wireless device to a wired network or other device without using a cable. The present invention also provides an efficient method for configuring and managing connections between a wireless device and other devices or networks.

The method of the present invention integrates network settings in a software user interface. This ensures that the user does not need to be concerned about network connection issues.

The software automatically resolves network connections and allows the user to easily access the network or device connected to the AP. Additionally, the software user interface allows the user to easily configure the connections between devices and networks.

In addition to wirelessly connecting a computer to a network, the present invention can also be used in different applications such as Wi-Fi speakers, Wi-Fi TV applications, etc. For example, a computer can wirelessly connect to the Wi-Fi speakers and audio files being played on the computer will be heard from the Wi-Fi speakers. Using the method of the present invention, users can easily connect to wireless enabled devices.

In the method of the present invention all application devices' default setting is AP mode. This means that when the device is powered on or reset, the device automatically configures as an access point.

Next, the computer scans and configures the settings for the device via a wireless connection. Since the device is automatically set to AP mode, the computer can easily detect the device and establish a connection.

The device can be set to AP client mode and perform applications via another AP. For example, in a network where there is already one AP and the new device is added, the new device will be detected as a second AP. The new device can then be reconfigured as an AP client connected to the original AP.

Once the wireless connection is established the computer can transmit data or content to the device.

In the present invention all connection information is stored in a database. The database tracks all wireless network configurations. If a previously available AP is not detected during scanning of the network the present invention will notify the user. The user can decide whether to rescan or remove the connection information.

Using the present invention users can easily reconfigure the configuration of the network and role of access points and access point clients. If any problems with the configuration of the network are encountered, users are notified and the problems can be easily resolved.

These and other objectives of the present invention will become obvious to those of ordinary skill in the art after reading the following detailed description of preferred embodiments.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings:

FIG. 1 is a block diagram illustrating a conventional wireless network environment;

FIG. 2 is a block diagram illustrating typical difficulty involved in using a conventional wireless network;

FIG. 3 is a block diagram illustrating a wireless network environment according to an embodiment of the present invention;

FIG. 4 is a flowchart illustrating a method for wirelessly connecting a computer to an AP according to an embodiment of the present invention;

FIG. 5A is a diagram illustrating a basic wireless environment according to an embodiment of the present invention;

FIG. 5B is a flowchart illustrating a method for configuring the wireless network environment illustrated in FIG. 5A according to an embodiment of the present invention;

FIGS. 5C-5H are diagrams illustrating a software user interface for the computer of the wireless network environment of FIG. 5A according to embodiments of the present invention;

FIG. 6A is a diagram illustrating a software user interface for a computer of a wireless network environment according to an embodiment of the present invention;

FIG. 6B is a flowchart illustrating a method for configuring the wireless network environment illustrated in FIG. 6A according to an embodiment of the present invention;

FIG. 6C is a diagram illustrating a software user interface for a computer of a wireless network environment according to an embodiment of the present invention; and

FIG. 6D is a diagram illustrating a software user interface warning message.

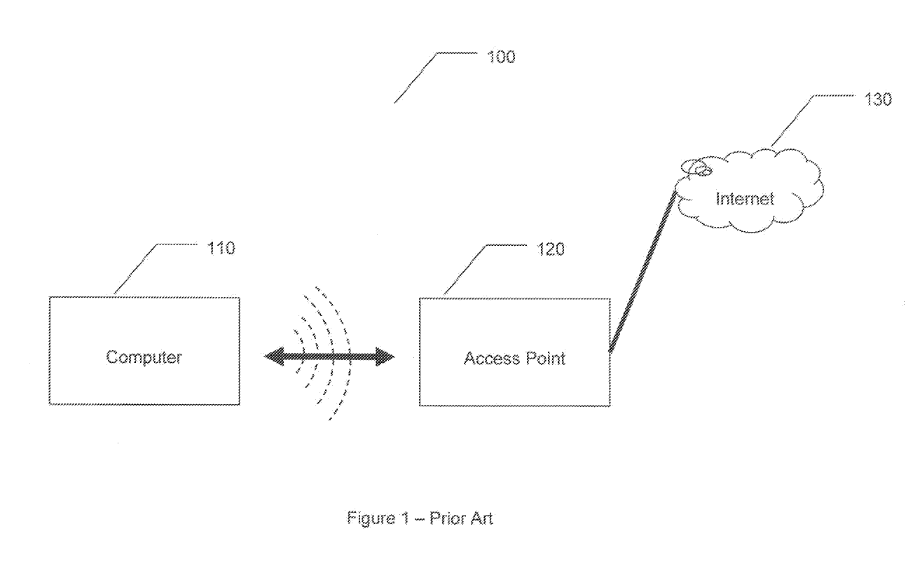

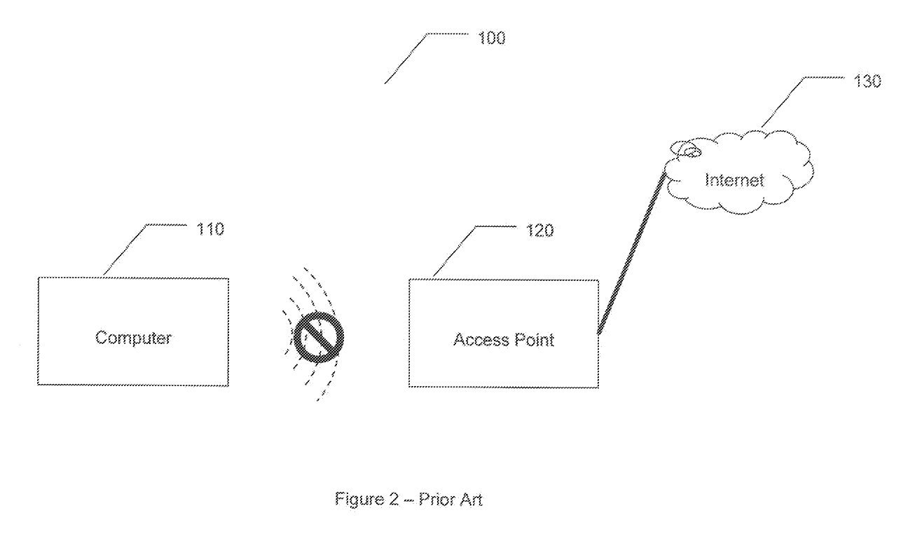

### DESCRIPTION OF THE PREFERRED EMBODIMENTS

Reference will now be made in detail to the preferred embodiments of the present invention, examples of which are illustrated in the accompanying drawings. Wherever possible, the same reference numbers are used in the drawings and the description to refer to the same or like parts.

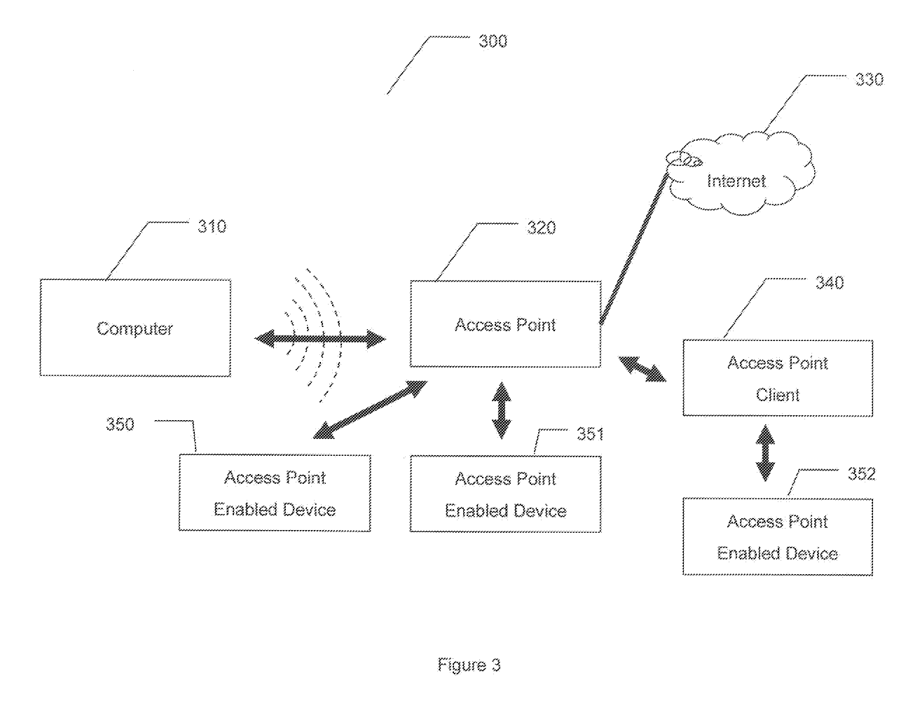

Refer to FIG. 3, which is a block diagram illustrating a wireless network environment according to an embodiment of the present invention.

Using the method of the present invention a wireless network environment 300 can be much more extensive while still being easy to configure and maintain.

Such an environment 300 as shown in FIG. 3 can comprise a computer 310, an access point 320, an access point client 340, access point enabled devices 350,351,352, and access to the Internet 330. The access point enable devices 350,351,352 can comprise, for example, an AP enabled TV, AP enabled speakers, AP enabled gaming devices, or AP enabled stereo system.

With the present invention the dream of a digital home can be realized. Media, for example music, that is stored on the computer can be easily listened to using an AP enabled audio device without physically connecting the computer to the audio device. This eliminates restraints on where users locate their devices.

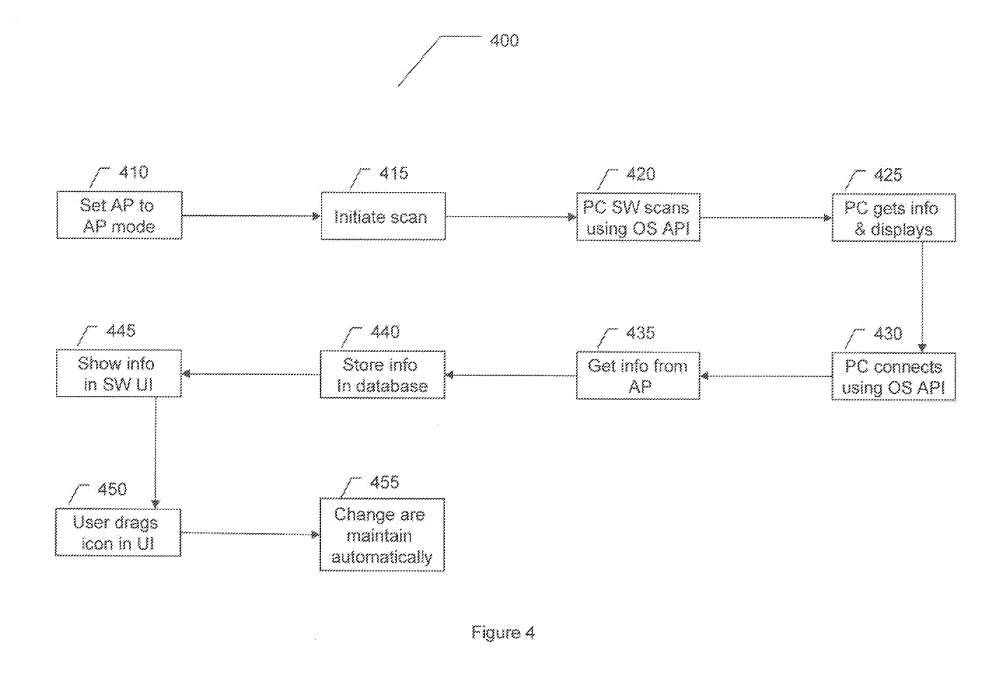

Refer to FIG. 4, which is a flowchart illustrating a method for wirelessly connecting a computer to an AP according to an embodiment of the present invention.

As shown in FIG. 4, the method of the present invention 400 begins by setting a device to AP mode upon power up or reset 410. A user selects to perform a scan by clicking the scan button of the software user interface 415. The computer will scan for any APs 420. The computer software will scan using the scan application programming interface (API) provided by the operating system.

The computer software gets the scanning information and displays it in the software user interface 425. The computer software then connects to the detected AP using the connect API provided by the operating system 430. After connecting to the AP, the computer gets the AP's information 435.

After performing the check the software stores all the data in the database 440 and displays appropriate information in the software user interface 445. The detected APs and connections are displayed in a topological diagram. The user can easily configure or reconfigure the connections by dragging icons of the devices in the software user interface 450. Any changes to the device hierarchy or device connections are automatically managed by the software 455. In this way the connections between devices is automatically reconfigured by the software to reflect changes made by the user. The user isn't required to manually reconfigure the network.

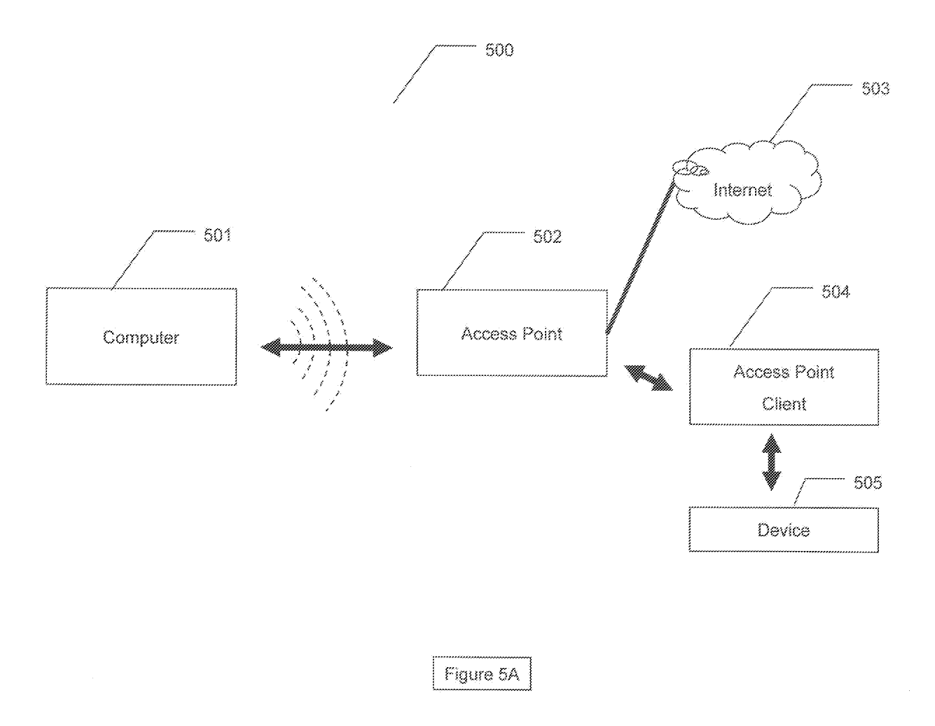

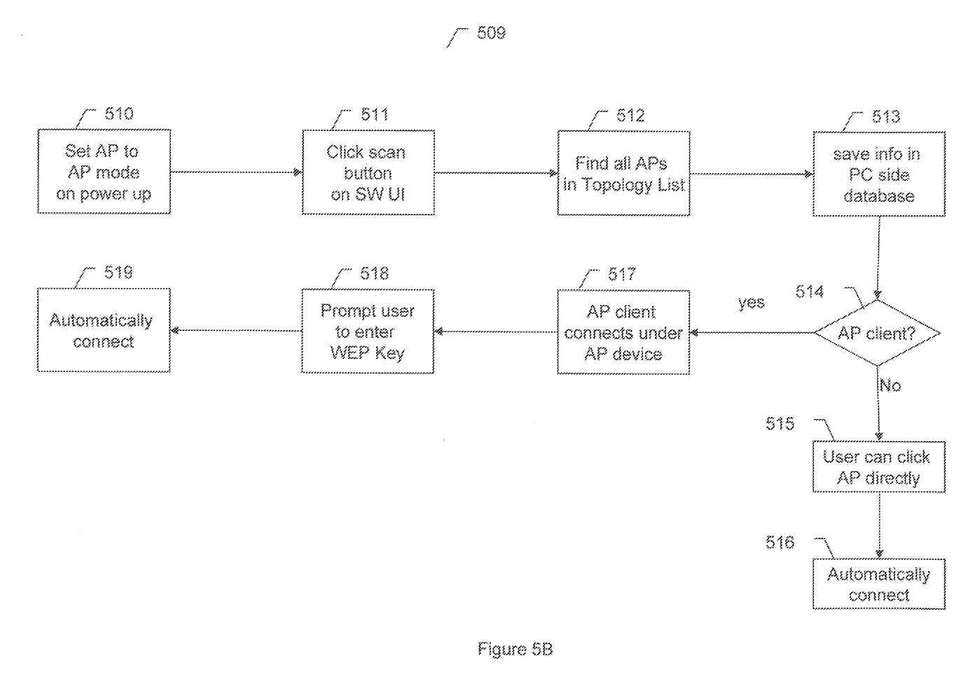

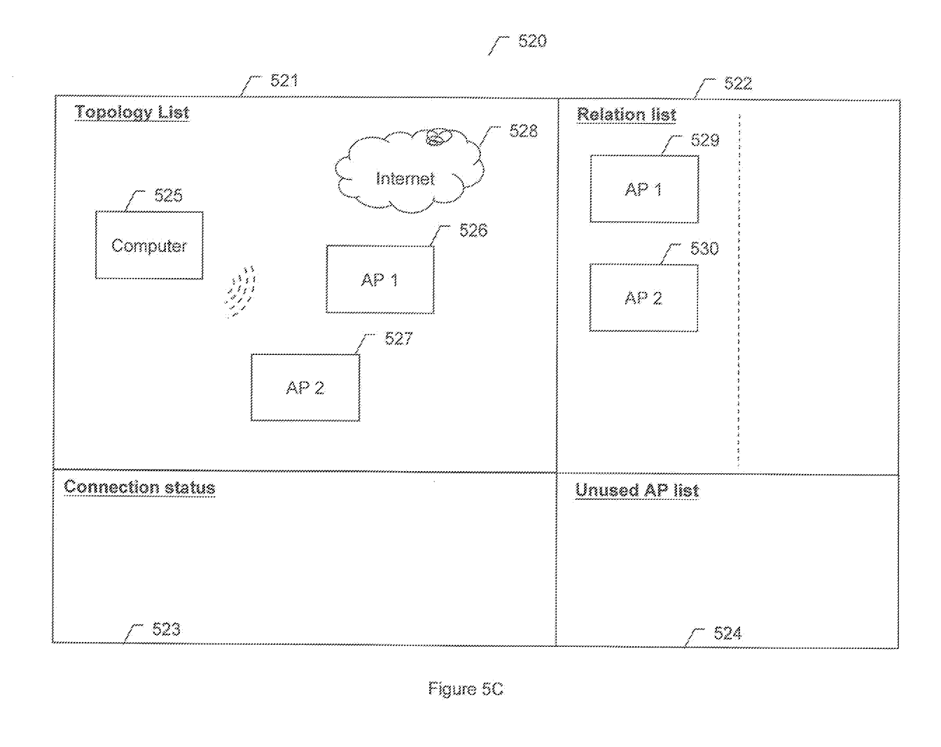

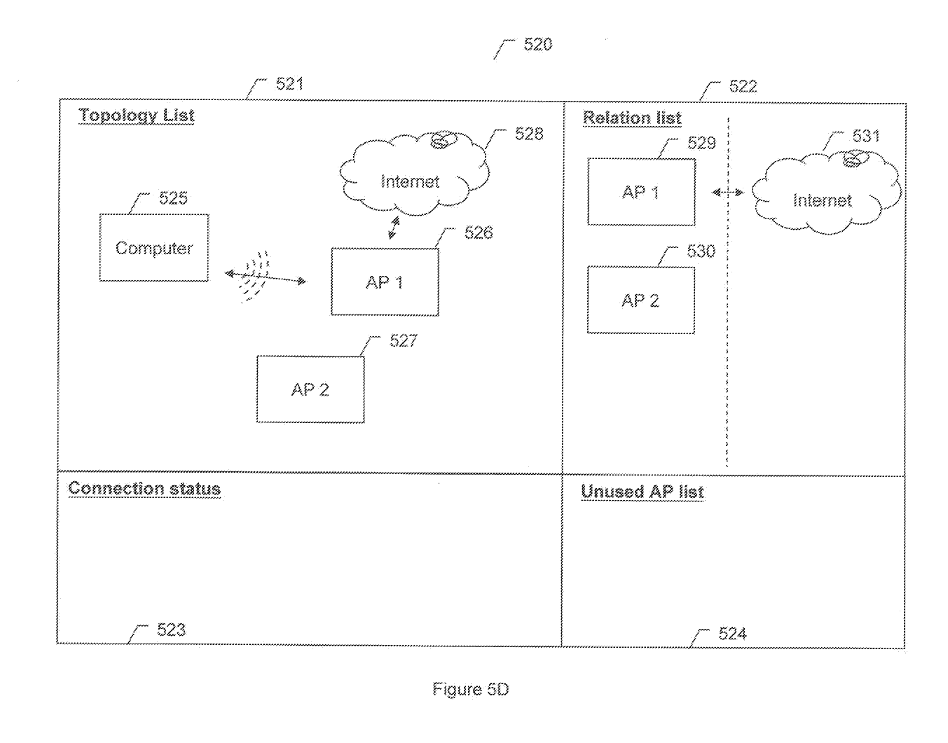

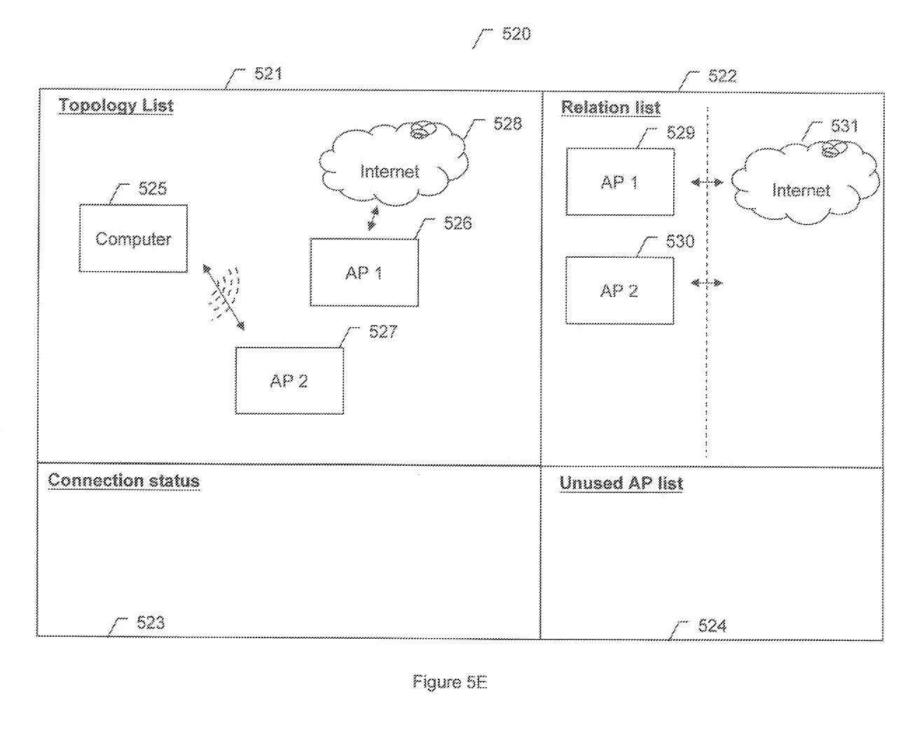

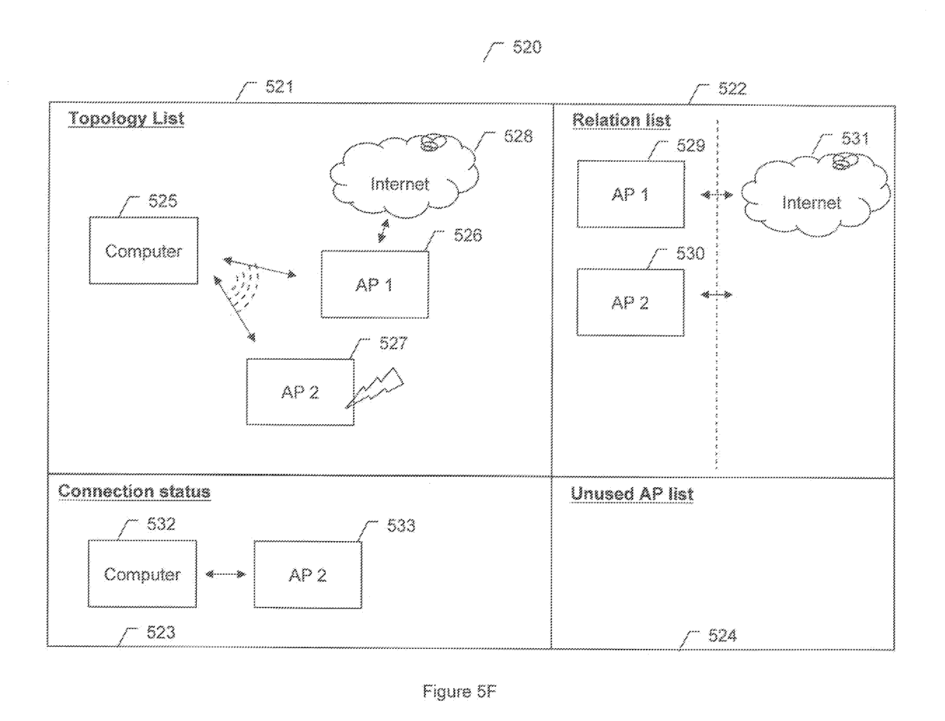

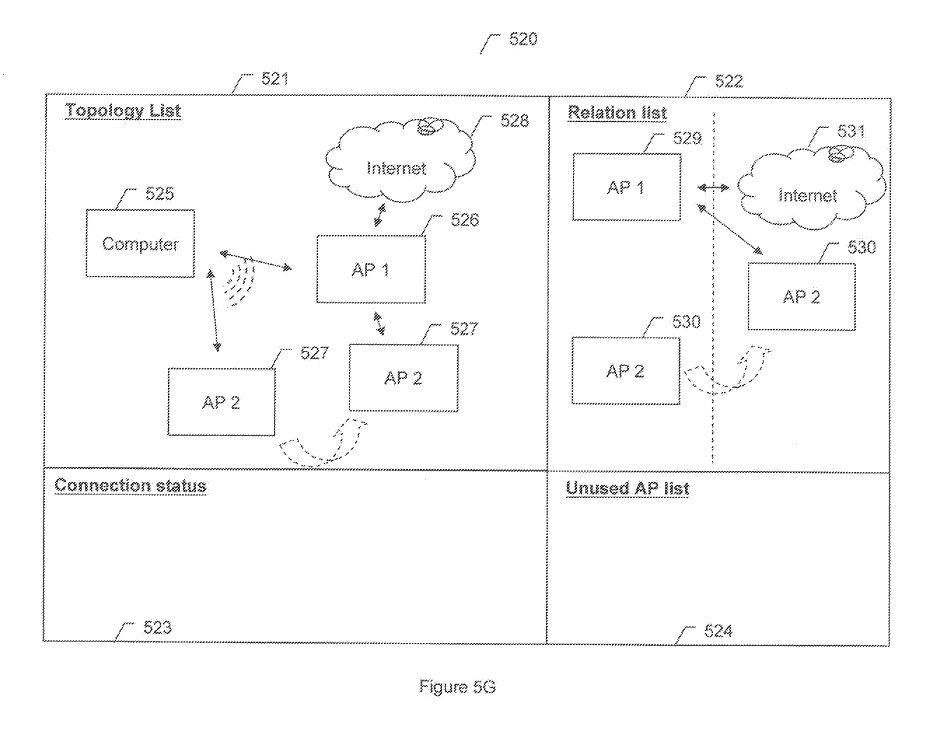

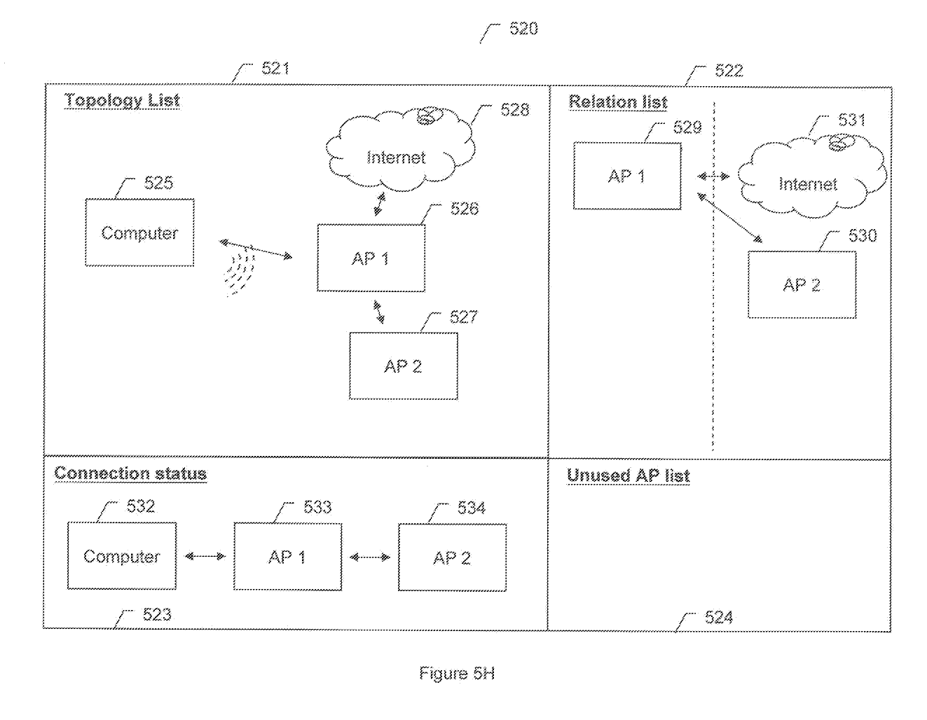

Refer to FIG. 5A, which is a diagram illustrating a basic wireless environment according to an embodiment of the present invention.

The wireless network environment 500 of FIG. 5A comprises a computer 501, a first AP 502, a second AP 504, a wireless device 505, and access to the Internet 503. A user can access internet resources using the first AP 502. The second AP 504 is configured as an AP client and connects the wireless device 505 to the computer 501 via the first AP 502.

Refer to FIG. 5B, which is a flowchart illustrating a method for configuring the wireless network environment illustrated in FIG. 5A according to an embodiment of the present invention.

As shown in FIG. 5B, the method of the present invention 509 begins by setting an AP device to AP mode upon power up or reset 510. A user selects to perform a scan by clicking the scan button of the software user interface 511. The computer will scan for all APs. The computer software will scan using the scan application programming interface (API) provided by the operating system.

The computer software will find all APs and display them in the topology diagram of the software user interface 512. The computer software saves all the scanning information in a computer side database 513.

In this example the computer detects the first AP and the second AP. Initially both the first AP and the second AP are displayed as master APs. The user decides whether connection should be made with the second AP or if the second AP should be configured as an AP client 514.

If the user decides that the computer is to connect to the second AP, the user simply clicks the second AP icon in the topological diagram of the software user interface 515. The computer software will then automatically connect the computer to the second AP 516.

If the user decides that the second AP should be an AP client, the second AP will connect under the first AP 517. If the user is required to enter a WEP key, a pop-up window will ask the user to enter the key 518. In a WEP key isn't required this step is skipped.

Finally, the computer software will automatically reconfigure the network so that the computer will connect to the second AP or AP client via the first AP 519.

Refer to FIG. 5C, which is a diagram illustrating a software user interface for the computer of the wireless network environment of FIG. 5A according to an embodiment of the present invention.

The software user interface 520 of the present invention comprises a topological list 521, a relation list 522, connection status 523, and an unused AP list 524.

After the computer 525 scans the environment, all detected APs 526,527 are display as icons in the topological list 521. In the example environment of FIG. 5A, the computer 525 detects a first AP 526 and a second AP 527 and the interface 520 displays both of these in the topological list 521.

The first AP 529 and the second AP 530 are displayed as icons in the relation list 522. The relation list comprises an AP section and a section showing devices or networks connected to the AP. Since both the first AP 529 and second AP 530 were detected as APs, they are displayed in the AP section. At this time, the other section is empty.

Refer to FIG. 5D, which is a diagram illustrating a software user interface for the computer of the wireless network environment of FIG. 5A according to an embodiment of the present invention.

In this example, the user selects to connect the computer 525 to the Internet 528 via the first AP 526. The user simply clicks on the first AP 526 icon in the topological list 521. The software saves the configuration information in the computer-side database and automatically configures the wireless environment. The topological list 521 of the software user interface 520 displays the connection between the computer 525 and the Internet 528 via the first AP 526.

The relation list 522 shows the first AP 529 in the AP section and the Internet 531 as being connected to the first AP 529 in the other section. At this time the second AP 530 is shown as being disconnected from the computer and Internet 531 in both the topological list 521 and the relation list 522.

Refer to FIG. 5E, which is a diagram illustrating a software user interface for the computer of the wireless network environment of FIG. 5A according to an embodiment of the present invention.

If the user decides that the computer 525 should connect to the second AP 527, the user simply clicks on the second AP 527 icon in the topological list 521. The software saves the configuration information in the computer-side database and automatically configures the wireless environment. The topological list 521 of the software user interface 520 displays the connection between the computer 525 and the second AP 527.

The relation list 522 shows the second AP 530 in the AP section and the other section is empty. At this time the first AP 529 is shown as being disconnected from the computer 525 but connected to the Internet 528 in both the topological list 521 and the relation list 522.

Refer to FIG. 5F, which is a diagram illustrating a software user interface for the computer of the wireless network environment of FIG. 5A according to an embodiment of the present invention.

Once AP configuration data is stored in the computer-side database, a user can simply click on an AP icon 527 in the topological list 521 and the software will automatically configure the environment.

The connection information is displayed in the connection status section 523 of the software user interface 520. In this example, the connection status section 523 shows the computer 532 connected to the second AP 533.

In an embodiment of the present invention, the second AP comprises an audio device, for example, a soundcard. Once the user clicks on the second AP in the topological list, audio being played by the computer is heard from the audio device. In this way, the present invention allows the computer to wirelessly connect to an audio device and audio normally heard from the computer's speakers can now be heard from the audio device. This allows users to listen to music on their quality home audio system rather than listening to the inferior audio quality from the computer speakers.

Refer to FIG. 5G, which is a diagram illustrating a software user interface for the computer of the wireless network environment of FIG. 5A according to an embodiment of the present invention.

If a user decides that the second AP 527 should be an AP client, the user simply drags the icon for the second AP 527 over to the first AP 526. The software reconfigures the second AP 527 as an AP client and saves the configuration information in the computer-side database. The software user interface 520 shows the computer 525 connected to the Internet 531 and second AP 530 via the first AP 529.

In situations where the user tries to configure the environment in a way that is not possible or where devices are incompatible, the software will notify the user that the connection or configuration is not possible. This prevents the user from inadvertently mis-configuring the environment.

Refer to FIG. 5H, which is a diagram illustrating a software user interface for the computer of the wireless network environment of FIG. 5A according to an embodiment of the present invention.

When the user wants the computer 525 to connect to the second AP 527, the user clicks on the icon for the second AP 527 and the computer 525 communicates with the second AP 527 via the first AP 526. The connection information is displayed in the connection status section 523.

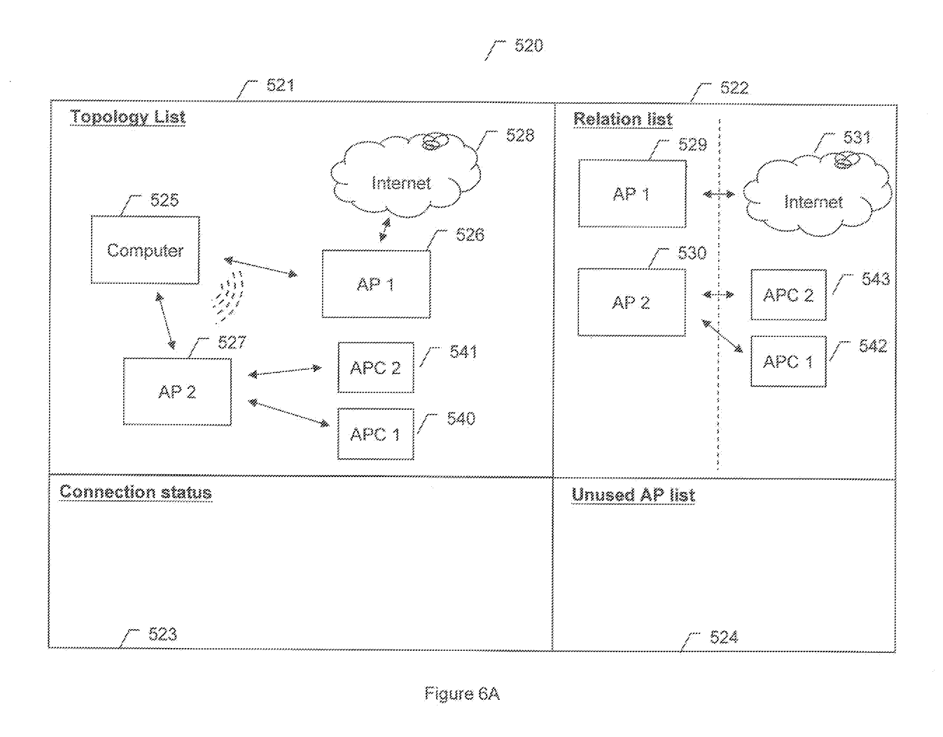

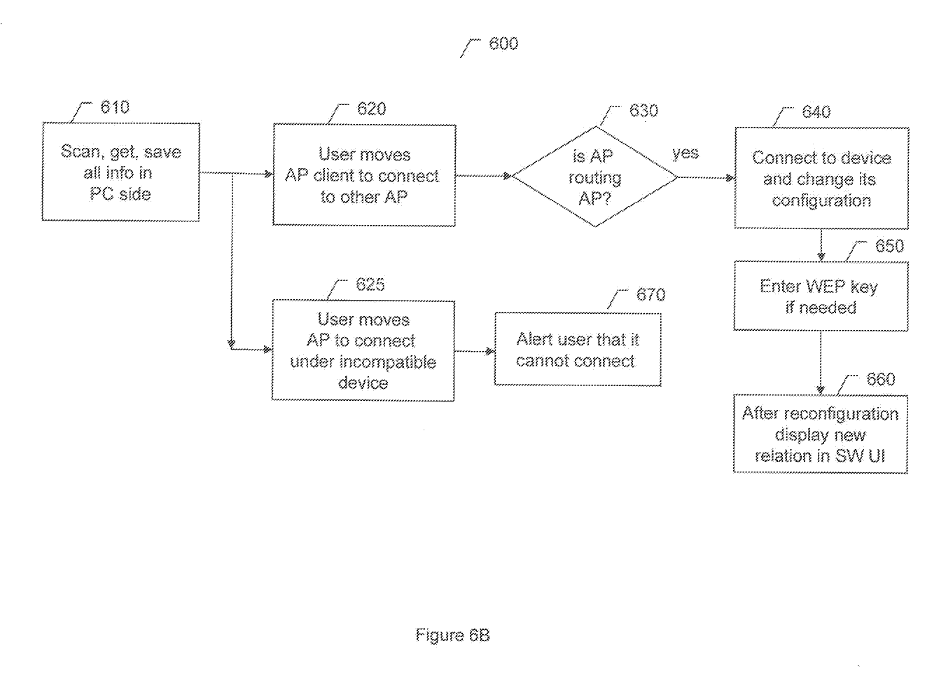

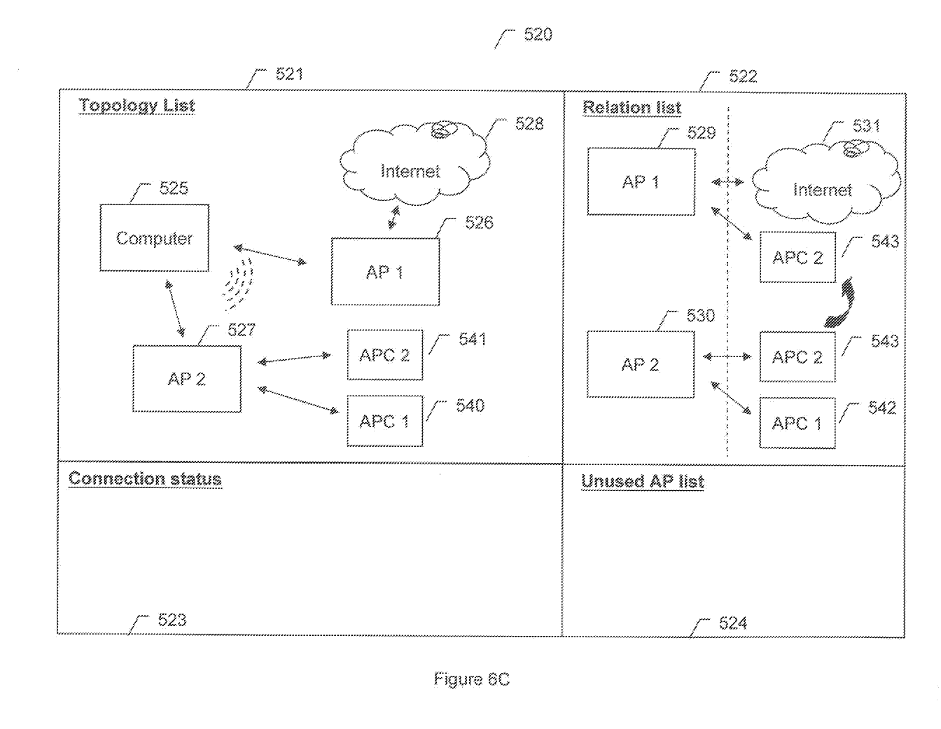

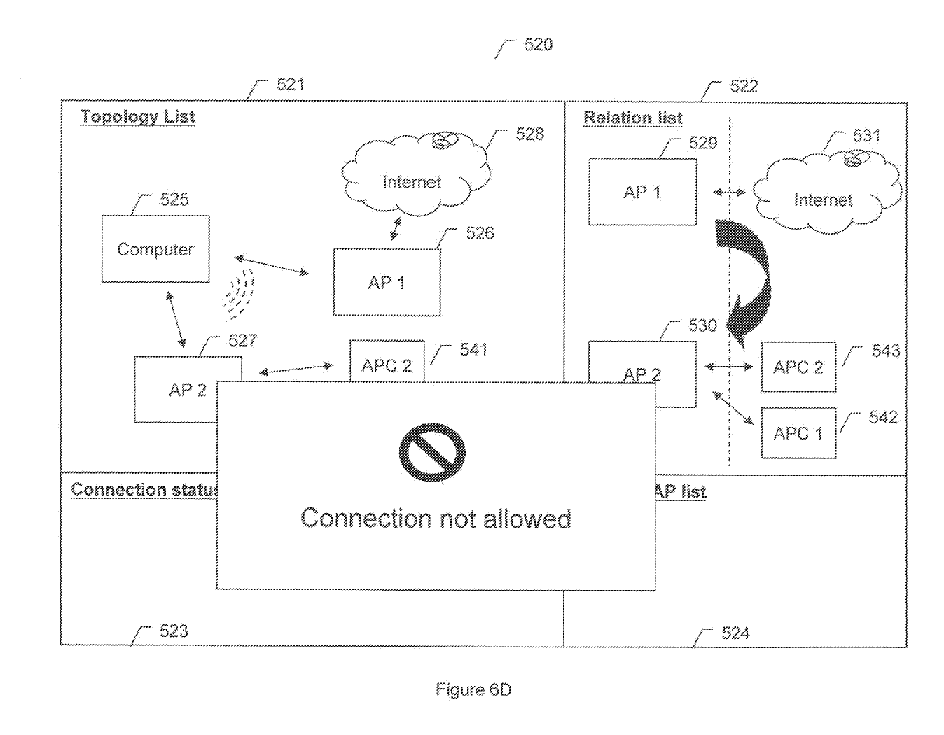

Refer to FIG. 6A, which is a diagram illustrating a software user interface for a computer of a wireless network environment according to an embodiment of the present invention.

The wireless network environment illustrated in FIG. 6A comprises a computer 525 connected to a first AP 526 and a second AP 527. The first AP 526 is configured to allow the computer 525 to access the Internet 528. A first AP client 540 and a second AP client 541 are connected to the second AP 527. The software user interface 520 displays the connection data in the topological list 521 and relation list 522.

Refer to FIG. 6B, which is a flowchart illustrating a method for configuring the wireless network environment illustrated in FIG. 6A according to an embodiment of the present invention, to FIG. 6C, which is a diagram illustrating a software user interface for a computer of a wireless network environment according to an embodiment of the present invention, and to FIG. 6D, which is a diagram illustrating a software user interface warning message.

The method 600 illustrated in FIG. 6B shows the steps taken to allow a user to reconfigure the network environment. The computer scans and saves all connection information in the computer-side database 610. The user drags an AP client over to the first AP in order to reconfigure network so that the AP client is under the first AP 620. Next, the software determines whether the first AP is a routing AP 630.

If the first AP is a routing AP the software will connect to the AP client and change its configuration to link to the first AP 640. If the AP requires a WEP key, the user is prompted to enter the key 650.

After the configuration is saved, the user will see the new configuration information in the software user interface 660 as shown in FIG. 6C.

In some cases a user may try to reconfigure the network in a manner that is invalid 625. For example, if a user dragged AP 1 to be under AP 2 which isn't allowed. The software will notify the user that the connection or configuration is not possible 670 and as shown in FIG. 6D. This prevents the user from inadvertently mis-configuring the environment.

When the user reconfigures the network environment the software automatically prompts the user with a message asking if the original connection and configuration information should be saved. In the above example, the first AP client was moved to be under the first AP. The original configuration comprised a first AP client and second AP client under a second AP. The software asks the users if the connection information for the first AP client and second AP client should be saved. If the user opts to save the information it is saved in the computer-side database. In this way, if the user reconfigures the environment back to the original state, the software retrieves the information from the database and automatically configures the environment.

If an AP client needs to be changed to AP mode, the software prompts the user as to whether the software should automatically reconfigure the AP client or not. If the user chooses not to reconfigure the AP client, the user can hard-reset the AP client and the AP will automatically restart in AP mode.

If the user wants to connect to an AP client and the computer cannot detect the master AP, the software will automatically scan for the master AP. If the software detects the master AP the connection information is stored in the connection database. If the computer still cannot detect the master AP, the software will prompt the user asking whether or not to keep the connection information. If the user wants to keep the information it is stored in the database. If the user doesn't want to keep the information it is discarded and the user is prompted to reset the AP client.

During the time that the computer cannot detect the master AP, the software user interface will show that there is a problem in connection status. This is illustrated in the topological list, the relation list, and the connection status section.

Similarly, if the user wants to connect to an AP client and the computer cannot detect the AP client, the software will automatically scan for the AP client. If the software detects the AP client the connection information is stored in the connection database. If the computer still cannot detect the AP client, the software will prompt the user asking whether or not to keep the AP client connection information. If the user wants to keep the information it is stored in the database. If the user doesn't want to keep the information it is discarded.

The software user interface shows the current connection and configuration status. When the computer can't detect an AP client, the situation will be displayed in the user interface.

When a user tries to add another AP or device that exceeds the maximum allowable devices or connections, the software will prompt the user to first remove the AP or device. The user can easily remove a device by clicking and dragging the icon for the device and placing the icon in the unused AP list. The icon for the device will be displayed in the unused AP list for future use. When the user wants to use the device, the user simply drags the device back into the relation list or the topological list.

After removing the device, the user is able to add the new device. The computer will connect to the device and configuration is achieved as described above. The connection information is saved in the computer-side database and the user interface shows the current connection status.

When a computer cannot detect a particular AP or AP client and the computer has an Ethernet connection, the computer scans to detect the AP or AP client via the Ethernet. If the computer detects the device, the computer will reconfigure the device as an Ethernet device. The device will now be displayed in the user interface as an Ethernet device in the unused AP list.

Similarly, if the computer is wirelessly connected to an AP with an Ethernet connection, the computer scans the Ethernet via the AP. If the computer detects the device, the computer will reconfigure the device as an Ethernet device.

As described above, the method of the present invention provides easy connection and configuration of electronic devices in a wireless network environment. Additionally, electronic devices do not need to be physically connected to access points via a cable in order to configure the connection.

It will be apparent to those skilled in the art that various modifications and variations can be made to the present invention without departing from the scope or spirit of the invention. In view of the foregoing, it is intended that the present invention cover modifications and variations of this invention provided they fall within the scope of the invention and its equivalent.

What is claimed is:

1. A method for configuring a wireless network environment comprising:
setting at least one access point in access point mode upon power up;
scanning the wireless network environment for available connections;
detecting the available connections; and
storing information about the available connections in a database.

2. The method for configuring a wireless network environment of claim 1, further comprising:
determining if the available connections are master access points or access point clients; and
automatically configuring the available connections as master access points or access point clients.

3. The method for configuring a wireless network environment of claim 2, further comprising:
selecting a master access point with available connection to be reconfigured as an access point client; and
automatically reconfiguring the selected master access point as an access point client.

4. The method for configuring a wireless network environment of claim 3, further comprising:
storing information regarding the reconfigured access point in the database.

5. The method for configuring a wireless network environment of claim 2, further comprising:
selecting an access point client with available connection to be reconfigured as a master access point; and
automatically reconfiguring the selected access point client as a master access point.

6. The method for configuring a wireless network environment of claim 5, further comprising:
storing information regarding the reconfigured access point in the database.

7. The method for configuring a wireless network environment of claim 1, further comprising:
producing an alert if a connection configuration is incompatible.

8. The method for configuring a wireless network environment of claim 1, further comprising:
reading the information in the database;
rescanning the wireless network environment for available connections; and
producing an alert if a previously available connection is not detected.

9. A method for configuring a wireless network environment comprising:
powering on at least one access point in access point mode;
scanning the wireless network environment for available connections;
detecting the available connections;
storing information about the available connections in a database;
determining if the available connections are master access points or access point clients; and
automatically configuring the available connections as master access points or access point clients.

10. The method for configuring a wireless network environment of claim 9, further comprising:
selecting a master access point with available connection to be reconfigured as an access point client; and
automatically reconfiguring the selected master access point as an access point client.

11. The method for configuring a wireless network environment of claim 10, further comprising:
storing information regarding the reconfigured access point in the database.

12. The method for configuring a wireless network environment of claim 9, further comprising:
selecting an access point client with available connection to be reconfigured as a master access point; and
automatically reconfiguring the selected access point client as a master access point.

13. The method for configuring a wireless network environment of claim 12, further comprising:
storing information regarding the reconfigured access point in the database.

14. The method for configuring a wireless network environment of claim 9, further comprising:
producing an alert if a connection configuration is incompatible.

15. The method for configuring a wireless network environment of claim 9, further comprising:
reading the information in the database;
rescanning the wireless network environment for available connections; and
producing an alert if a previously available connection is not detected.

16. A method for configuring a wireless network environment comprising an electronic device and at least one access point, the method comprising:
automatically setting at least one access point in access point mode upon power up;
scanning the wireless network environment for available connections by the electronic device;
detecting the available connections;
storing information about the available connections in a database in the electronic device;
determining if the available connections are master access points or access point clients; and
automatically configuring the available connections as master access points or access point clients by the electronic device.

17. The method for configuring a wireless network environment of claim 16, further comprising:
selecting a master access point with available connection to be reconfigured as an access point client; and
automatically reconfiguring the selected master access point as an access point client by the electronic device.

18. The method for configuring a wireless network environment of claim 17, further comprising:
storing information regarding the reconfigured access point in the database.

19. The method for configuring a wireless network environment of claim 16, further comprising:
selecting an access point client with available connection to be reconfigured as a master access point; and
automatically reconfiguring the selected access point client as a master access point by the electronic device.

20. The method for configuring a wireless network environment of claim 19, further comprising:
storing information regarding the reconfigured access point in the database.

21. The method for configuring a wireless network environment of claim 16, further comprising:
producing an alert if a connection configuration is incompatible.

22. The method for configuring a wireless network environment of claim 16, further comprising:
reading the information in the database;
rescanning the wireless network environment for available connections; and
producing an alert if a previously available connection is not detected.

23. A method for configuring a wireless network environment comprising an electronic device and at least one access point, the method comprising:
automatically setting at least one access point in access point mode on power up;
scanning the wireless network environment for access points with available connections by the electronic device;
detecting the access points with available connections;
storing information about the access points with available connections in a database in the electronic device;
determining if the access points with available connections are master access points or access point clients; and
automatically configuring the access points with available connections as master access points or access point clients by the electronic device.

24. The method for configuring a wireless network environment of claim 23, further comprising:
selecting a master access point with available connection to be reconfigured as an access point client; and
automatically reconfiguring the selected master access point as an access point client by the electronic device.

25. The method for configuring a wireless network environment of claim 24, further comprising:
storing information regarding the reconfigured access point in the database.

26. The method for configuring a wireless network environment of claim 23, further comprising:
selecting an access point client with available connection to be reconfigured as a master access point; and
automatically reconfiguring the selected access point client as a master access point by the electronic device.

27. The method for configuring a wireless network environment of claim 26, further comprising:
storing information regarding the reconfigured access point in the database.

28. The method for configuring a wireless network environment of claim 23, further comprising:
producing an alert if a connection configuration is incompatible.

29. The method for configuring a wireless network environment of claim 23, further comprising:
reading the information in the database;
rescanning the wireless network environment for available connections; and
producing an alert if a previously available connection is not detected.
